(19) United States
(12) Patent Application Publication
(10) Pub. No.: US 2009/0052744 A1
(43) Pub. Date: Feb. 26, 2009

(54) APPLICATION-PROCEDURE FRAUD RISK EVALUATION APPARATUS

(75) Inventors: Hironobu KITAJIMA, Kawasaki (JP); Ryo OCHITANI, Kawasaki (JP); Morio IKESAKA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/194,215

(22) Filed: Aug. 19, 2008

(30) Foreign Application Priority Data
Aug. 20, 2007 (JP) 2007-213620

(51) Int. Cl. G06K 9/00

(52) U.S. Cl. 382/112

(57) ABSTRACT

An application-procedure fraud risk evaluation apparatus having a unit for preparing, based on relationships between each document for identity verification and other one or more documents and procedures required for acquiring the each document for identity verification, relationships between a document group and procedures which are required to acquire a target document for identity verification, which is necessary in a predetermined application, and for holding the prepared relationships as an identity verification diagram for the predetermined application; a unit for accepting, as fraud case data, fraudulent cases that have occurred in the application procedures and/or in acquiring the each document for identity verification; and a unit for evaluating, based on the identity verification diagram and the fraud case data, in which one of the documents for identity verification a fraudulent document is presented with a higher possibility when fraudulent applications are performed in the application procedures.

### CROSS-REFERENCE TO RELATED APPLICATIONS

This application is based upon and claims the benefit of priority from the prior Japanese Patent Application No. 2007-213620 filed on Aug. 20, 2007, the entire contents of which are incorporated herein by reference.

### BACKGROUND OF THE INVENTION

1. Field of the Invention

An application-procedure fraud risk evaluation apparatus.

2. Description of the Related Art

Generally, in a predetermined application, a competent authority (party) steps into a procedure after requesting an applicant to present a document for identity verification. This is intended to prevent the applicant from trying to pass the application procedure under the guise of another person and to abuse benefits provided after passing the application procedure. Herein, the term “application procedure” means a general procedure in which, through transfer of documents, etc. between an applicant and a competent authority, the competent authority provides some benefits to the applicant at the discretion of the competent authority based on the will of the applicant and the fact relevance.

The document used for identity verification in the application procedure is just one document or a set of plural documents depending on a required level of identity verification. Such a document for identity verification is issued by a public organization, for example. The document is issued after an applicant has taken a necessary predetermined application procedure.

Also in that application procedure, a competent authority requests the applicant to present a lower-level document for identity verification. Such a lower-level document for identity verification is often similarly employed to progress identity verification in a plurality of different applications. Consequently, the lower-level document requested for identity verification by the competent authority is overlapped between or among the plurality of applications, thus resulting in a complicated chain-like situation of identity verification.

In addition to procedures which are progressed through actual transfers of documents, etc. between persons, there are procedures in electronic form. One example of the procedures in electronic form is a payment procedure using credit cards. Regarding the payment procedure using credit cards, a method of computing a possibility of a fraudulent credit-card transaction is proposed. For example, Japanese Unexamined Patent Application Publication No. 2004-334527 discloses a method of computing a score value indicating a possibility of a fraudulent credit-card transaction based on received authority data (i.e., data including various items of information generated in the credit-card transaction, such as information of the credit card owner and information of the settlement amount using the credit card).

When an applicant attempting to pass the application procedure and to obtain benefits under the guise of another person presents the document for identity verification in response to a request from the competent authority, the applicant presents either a document that is genuine, but which has been obtained under the guise of another person, or an utterly fraudulent document. In order to obtain the genuine document for identity verification under the guise of another person in any stage, the applicant should have made an application to, e.g., a public organization for issuance of the document. In that application, the applicant should have also presented either a document that is genuine, but which had been obtained under the disguise of another person, or an utterly fraudulent document.

Thus, there are plural scenes of identity verification until the applicant reaches the target application procedure. In such a situation, the applicant should attempt to impersonate in one of the plural scenes of identity verification where committing a fraud seems to be relatively easy. For that reason, it is desired to quantitatively evaluate which part in a series of application procedures up to the predetermined target application procedures is relatively easily susceptible to a fraud regarding identity verification, to improve the application procedures based on the evaluation result, and to reestablish a series of application procedures which are robust against frauds.

### SUMMARY OF THE INVENTION

According to an aspect of an embodiment, there is provided an application-procedure fraud risk evaluation apparatus comprising an identity verification diagram holding unit for preparing, based on relationships between each document for identity verification and one or more other documents and procedures required for acquiring the each document for identity verification, relationships between a document group and procedures which are required to acquire a target document for identity verification, which is necessary in a predetermined application, and for holding the prepared relationships as an identity verification diagram for the predetermined application; a fraud case data accepting unit for accepting, as fraud case data, fraudulent cases that have occurred in the application procedures and/or in acquiring the each document for identity verification; and a fraud risk evaluating unit for evaluating, based on the identity verification diagram and the fraud case data, in which one of the documents for identity verification a fraudulent document is presented with a higher possibility when fraudulent applications are performed in the application procedures.

The above-described embodiments of the present invention are intended as examples, and all embodiments of the present invention are not limited to including the features described above.

### BRIEF DESCRIPTION OF THE DRAWINGS

FIG. 1 is a block diagram showing a configuration of an application-procedure fraud risk evaluation apparatus according to a first embodiment;

FIG. 2 is an identity verification diagram of an application for issuance of a passport;

FIG. 3 is a table showing an example of a data structure when the identity verification diagram is stored;

FIG. 4 is a diagram for explaining concrete examples of fraudulent case data in applications for issuance of passports;

FIG. 5 is a table showing an example of a data structure when the fraudulent case data is accepted;

FIG. 6 is a flowchart showing a process to determine a probability formula;

FIG. 7 is an example of information displayed on a display;

FIG. 8 is a block diagram showing a configuration of an application-procedure fraud risk evaluation apparatus according to a second embodiment;

FIG. 9 is a flowchart for explaining a method of obtaining an estimated value based on a questionnaire survey;

FIG. 10 is an example of information displayed on the display;

FIG. 11 is an example of information displayed on the display;

FIG. 12 is a block diagram showing a configuration of an application-procedure fraud risk evaluation apparatus according to a third embodiment;

FIG. 13 is a graph showing an example of a distribution of periods during which frauds have occurred in applications for issuance of passports; and

FIG. 14 is an example of information displayed on the display.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

An application-procedure fraud risk evaluation apparatus described below provides an apparatus capable of quantitatively evaluating a fraud risk in a chain-like situation of identity verification in which plural types of application procedures are linked with one another.

Preferred embodiments of the application-procedure fraud risk evaluation apparatus will be described in detail with reference to the drawings.

### Configuration of Application-Procedure Fraud Risk Evaluation Apparatus According to First Embodiment

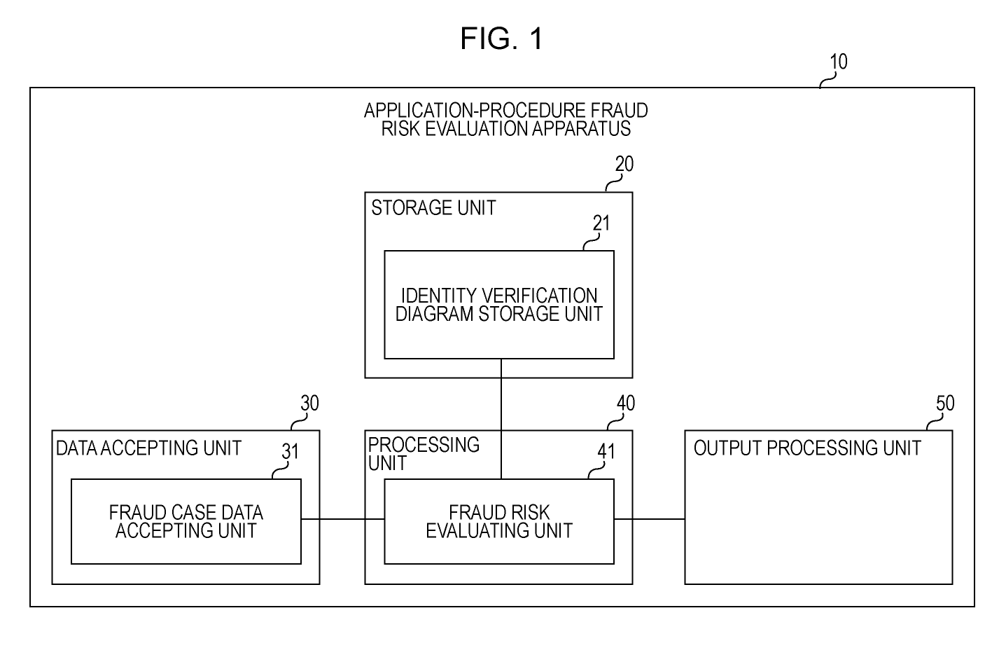

The configuration of the application-procedure fraud risk evaluation apparatus according to the first embodiment will be described with reference to FIG. 1. FIG. 1 is a block diagram showing the configuration of the application-procedure fraud risk evaluation apparatus according to the first embodiment.

As shown in FIG. 1, an application-procedure fraud risk evaluation apparatus 10 comprises a storage unit 20, a data accepting unit 30, a processing unit 40, and an output processing unit 50.

The storage unit 20 stores, for example, data that is used in various types of processes executed by the processing unit 40. As a part closely related to the present invention, in particular, the storage unit 20 includes an identity verification diagram storage unit 21. Note that the identity verification diagram storage unit 21 corresponds to “identity verification diagram holding means” stated in claims.

The identity verification diagram storage unit 21 prepares, based on relationships between each document for identity verification and one or more other documents and procedures required for acquiring the relevant document for identity verification, relationships between a document group and procedures which are required to acquire a target document for identity verification, which is necessary in a predetermined application. The identity verification diagram storage unit 21 then stores the prepared relationships as an identity verification diagram for the predetermined application.

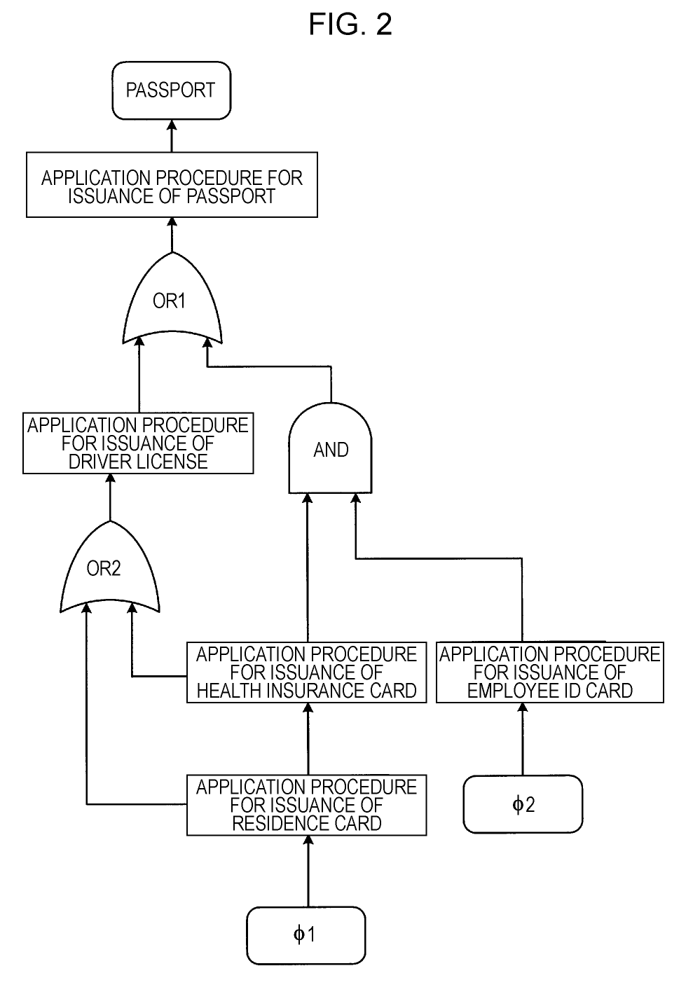

One example of the identity verification diagram stored in the identity verification diagram storage unit 21 will be described with reference to FIG. 2. FIG. 2 illustrates the identity verification diagram of an application for issuance of a passport.

In FIG. 2, a rectangular box indicates either an application procedure for each document for identity verification, including a passport, which is required to apply for issuance of a passport, or an application procedure for each document which is required until obtaining the aforesaid document. An arrow coming into the rectangular box corresponds to a document for identity verification, which an applicant is requested to present in the relevant application procedure. Also, an arrow going out from the rectangular box corresponds to a document issued after completion of the relevant application procedure.

A logical gate AND indicates that a document to be presented for identity verification is provided by a set of plural documents for identity verification. Further, a logical gate OR indicates that there are plural documents or plural sets of documents which are regarded as documents to be presented for identity verification and which are optionally selectable. In addition, “φ” explicitly expresses the procedure for which any formal certificate is not essential.

In other words, a driver's license alone or a set of a health insurance card and an employee ID card is accepted as the document(s) for identity verification, which is required to apply for issuance of a passport. Also, a health insurance card alone or a residence card alone is accepted as the document for identity verification, which is required to apply for issuance of a driver's license. Further, a residence card alone is accepted as the document for identity verification, which is required to apply for issuance of a health insurance card.

An applicant is not always required to present a document for identity verification in applying for issuance of a residence card and an employee ID card. For example, a residence card is issued when there is an inquiry card sent to the address of an applicant, and an employee ID card is issued without needing a particular document such as some document for identity verification. The foregoing is the identity verification diagram related to the application for issuance of the passport.

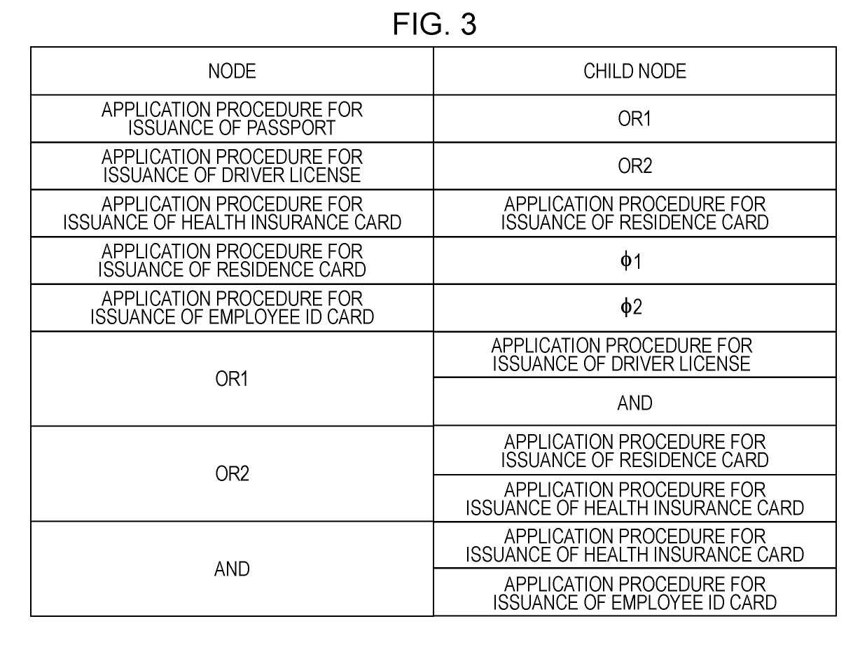

The identity verification diagram storage unit 21 stores the identity verification diagram, shown in FIG. 2, in a data structure shown, by way of example, in FIG. 3. More specifically, as shown in FIG. 3, the identity verification diagram storage unit 21 stores nodes indicating all the procedures and the logical gates in a corresponding relation to child nodes which are subordinate to the associated nodes, respectively. For example, as seen from FIG. 3, the identity verification diagram storage unit 21 stores a node “application procedure for issuance of passport” and a child node “OR1” in a corresponding relation to each other. FIG. 3 is a table showing an example of the data structure when the identity verification diagram is stored.

The data accepting unit 30 accepts predetermined data entered by a user. As a part closely related to the present invention, in particular, the data accepting unit 30 includes a fraud case data accepting unit 31. Note that the fraud case data accepting unit 31 corresponds to “fraud case data accepting means” stated in claims.

The fraud case data accepting unit 31 accepts, as fraud case data, fraud cases which have occurred in the application procedures and/or in acquiring some document for identity verification.

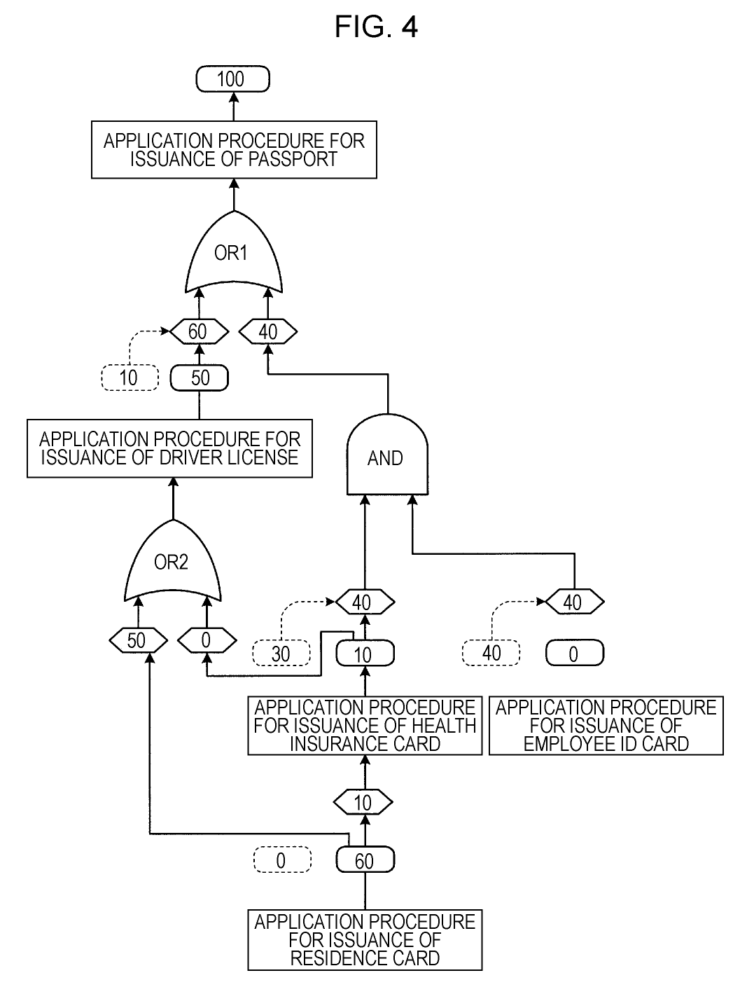

Concrete examples of the fraudulent case data accepted by the fraud case data accepting unit 31 will be described with reference to FIG. 4. FIG. 4 is a diagram for explaining the concrete examples of the fraudulent case data in applications for issuance of passports.

Referring to FIG. 4, the number of cases where the applicant has fraudulently passed the application procedure for issuance of the passport under the guise of another person is 100. Among those 100 cases, the number of cases where the applicant has presented a driver's license as the document for identity verification is 60, and the number of cases where the applicant has presented a set of a health insurance card and an employee ID card as the documents for identity verification is 40. Those 100, 60 and 40 cases constitute the fraud case data representing fraud cases which have occurred in the application procedures for issuance of the passports.

Among the 60 cases where the driver's license has been presented as the document for identity verification, the number of cases where the presented driver's license is utterly fraudulent is 10, and the number of cases where the presented driver's license is genuine, but has been acquired by impersonation is 50. Those 60, 10 and 50 cases constitute the fraud case data representing fraud cases which have occurred in acquiring the driver's licenses.

In all the 50 cases where the applicant has fraudulently passed the application procedure for issuance of the driver's license under the guise of another person, residence cards have been presented as the documents for identity verification. The number of cases where a health insurance card has been presented as the document for identity verification is 0. Those 50, 0 and 50 cases constitute the fraud case data representing fraud cases which have occurred in the application procedures for issuance of the driver's licenses.

Among the 40 cases where the set of the health insurance card and the employee ID card has been presented as the documents for identity verification, the number of cases where the presented health insurance card is utterly fraudulent is 30, and the number of cases where the presented health insurance card is genuine, but has been acquired by impersonation is 10. Further, the presented employee ID cards are all utterly fraudulent. Those 40, 30 and 10 cases and 40, 40 and 0 cases constitute the fraud case data representing fraud cases which have occurred in acquiring the health insurance cards and the employee ID cards, respectively.

Further, the number of cases where the applicant acquires the residence card by impersonation and presents the residence card in the application procedure for issuance of the driver's license is 50. The number of cases where the applicant acquires the residence card by impersonation and presents the residence card in the application procedure for issuance of the health insurance card is 10. The foregoing represents the concrete examples of the fraud case data.

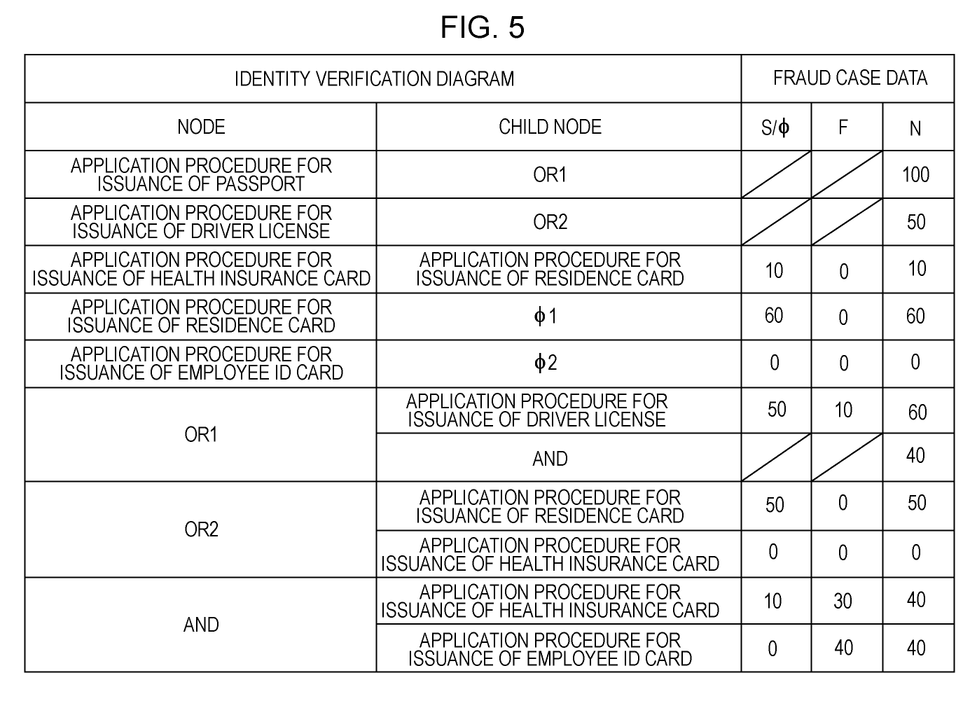

The fraud case data accepting unit 31 accepts the fraud case data, described above with reference to FIG. 4, in a data structure shown, by way of example, in FIG. 5. Then, the fraud case data accepting unit 31 outputs the accepted fraud case data to a fraud risk evaluating unit 41 (described later). In a table of FIG. 5, “S/φ” represents the number of cases of impersonations that have occurred between the node and the child node corresponding to the relevant node (when the child node is “φ”, it represents the number of cases of frauds because any document for identity verification is not required and impersonation does not occur).

Also, “F” in the table represents the number of cases of forgeries that have occurred between the node and the child node corresponding to the relevant node. Further, “N” in the table represents the total number of fraudulent applications that have occurred between the node and the child node corresponding to the relevant node. FIG. 5 is the table showing an example of the data structure when the fraudulent case data is accepted.

The processing unit 40 has an internal memory for storing programs specifying various kinds of processes and control data. The processing unit 40 serves as a processor for executing various kinds of processes by using the programs and the control data. As a part closely related to the present invention, in particular, the processing unit 40 includes the fraud risk evaluating unit 41. Note that the fraud risk evaluating unit 41 corresponds to “fraud risk evaluating means” stated in claims.

Based on the identity verification diagram and the fraud case data, the fraud risk evaluating unit 41 evaluates in which one of the documents for identity verification a fraudulent document is presented with a higher possibility when fraudulent applications are performed in the predetermined application procedure.

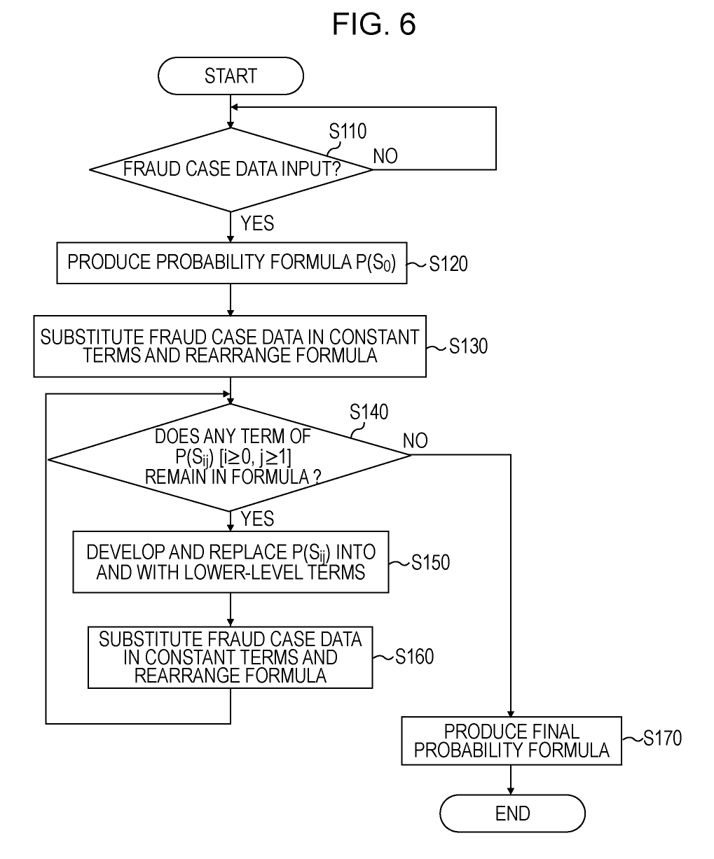

A practical example of the process executed by the fraud risk evaluating unit 41 will be described with reference to FIG. 6. As shown in FIG. 6, when the fraud case data is input from the fraud case data accepting unit 31 (Yes in operation S110), the fraud risk evaluating unit 41 reads out the identity verification diagram from the identity verification diagram storage unit 21 and produces a formula 1 as a probability formula (operation S120). Then, the fraud risk evaluating unit 41 substitutes the fraud case data in constant terms and rearranges the formula (operation S130).

$$\begin{matrix}[ Formula 1 ] & \\ P ( {S}_{0} ) = {\sum }_{i} {C}_{i} {\prod }_{j} \{ P ( E \vert {S}_{ij} ) \cdot P ( {S}_{ij} ) + P ( E \vert {F}_{ij} ) \cdot P ( {F}_{ij} ) \} & ( 1 )\end{matrix}$$

More specifically, assuming that Di is a combination which is accepted as one or more documents for identity verification in the predetermined application procedure and dij is each of the documents belonging to the combination, P(S0) represents a probability that the applicant tries to pass the predetermined application procedure under the guise of another person and succeeds in passing it. Herein, P(E|Sij) represents a probability that the document dij which was acquired by impersonation is overlooked. P(Sij) represents a probability that the document dij has been already acquired by impersonation. P(E|Fij) represents a probability that the forged document dij is overlooked. P(Fij) represents a probability that the document dij has been forged. Ci represents a probability that the combination Di is selected as the documents for identity verification, which are to be presented.

For example, the following formula 2 is produced from the identity verification diagram shown in FIGS. 2 and 3. By substituting the fraud case data in the formula 2 and rearranging it, the following formula 3 is obtained.

$$\begin{matrix}[ Formula 2 ] & \\ P ( {s}_{0} ) = {C}_{0} \cdot \{ P ( {S}_{01} ) + P ( E \vert {F}_{01} ) \cdot P ( {F}_{01} ) \} + {C}_{1} \cdot \{ P ( {S}_{11} ) + P ( E \vert {F}_{11} \} \cdot P ( {F}_{11} ) \} \cdot \{ P ( {S}_{12} ) + P ( E \vert {F}_{12} ) \cdot P ( {F}_{12} ) \} & ( 2 ) \\ [ Formula 3 ] & \\ P ( {S}_{0} ) = 0.6 \cdot \{ P ( {S}_{01} ) + 1 \text{/} 6 \cdot P ( E \vert {F}_{01} ) \} + 0.4 \cdot \{ P ( {S}_{11} ) + 3 \text{/} 4 \cdot P ( E \vert {F}_{11} ) \} \cdot P ( E \vert {F}_{12} ) & ( 3 )\end{matrix}$$

In other words, P(S0) represents a probability that the applicant tries to pass the application procedure for issuance of the passport under the guise of another person and succeeds in passing it. Herein, the term of i=0 and j=1 represents a probability that a driver's license is presented as the document for identity verification and is overlooked. Also, the product of the term of i=1 and j=1 and the term of i=1 and j=2 represents a probability that a set of a health insurance card and an employee ID card is presented as the documents for identity verification and is overlooked. The reason why P(E|Sij)=1 is assumed here is as follows. Although the document for identity verification which has been acquired by impersonation is a fraudulent document, the document has been acquired through the normal procedure. In this embodiment, therefore, P(E|Sij)=1 is set on the assumption that it is impossible for the competent authority to find the relevant document for identity verification as being acquired by impersonation.

Returning to operation S130, the fraud risk evaluating unit 41 determines whether any term of P(Sij) [i≧0, j≧1] remains in the formula and if it can be developed (operation S140). If any term of P(Sij) [i≧0, j≧1] remains (Yes in operation S140), the fraud risk evaluating unit 41 develops and replaces P(Sij) into and with lower-level terms based on the identity verification diagram (operation S150).

The fraud risk evaluating unit 41 then substitutes the fraud case data in constant terms and rearranges the formula (operation S160). The fraud risk evaluating unit 41 repeatedly executes the process from operation S140 to operation S160 until the term of P(Sij) [i≧0, j≧1] does not remains any more. According to the identity verification diagram shown in FIGS. 2 and 3, for example, the following formulae 4 and 5 are produced. Further, the following formula 6 is obtained by substituting the fraud case data and rearranging the resulting formula.

[Formula 4]

P(S₀₁)=C₃·{P(S₂₁)+P(E|F₂₁)·P(F₂₁)}+C₄·{P(S₁₁)+P(E|F₁₁)}·P(F₁₁) (4)

More specifically, P(S01) represents a probability that the applicant tries to pass the application procedure for issuance of the driver's license under the guise of another person and succeeds in passing it. Herein, the term of i=2 and j=1 represents a probability that a residence card is presented as the document for identity verification and is overlooked. Also, the term of i=1 and j=1 represents a probability that a health insurance card is presented as the document for identity verification and is overlooked. Note that P(E|S21)=1 is assumed here for the same reason as that described above.

Formula [5]

P(S₁₁)=C₅·{P(S₂₁)+P(E|F₂₁)·P(F₂₁)} (5)

More specifically, P(S11) represents a probability that the applicant tries to pass the application procedure for issuance of the health insurance card under the guise of another person and succeeds in passing it. Herein, the term of i=2 and j=1 represents a probability that a residence card is presented as the document for identity verification and is overlooked.

[Formula 6]

P(S₀)=0.6·{P(S₂₁)+⅙·P(E|F₀₁)}+0.4·{P(S₂₁)+¾·P(E|F₁₁)}·P(E|F₁₂) (6)

The formula 6 is obtained by replacing the formula 3 based on the formulae 4 and 5 which are developed into lower-level terms, and by substituting the fraud case data in the modified formula and rearranging it.

Because the term of P(Sij) [i≧0, j≧1] still remains in the formula 6, the following formula 7 is produced from the identity verification diagram as shown in FIGS. 2 and 3. By substituting the fraud case data in the formula 7 and rearranging it, the following formula 8 is obtained.

[Formula 7]

P(S₀₁)=P(S_{φ})·P(E|φ) (7)

More specifically, P(S21) is the product of P(Sφ) representing a probability that when the applicant selects the driver's license as the document for identity verification in the application procedure for issuance of the passport, the residence card required in the application procedure for issuance of the driver's license has been acquired by impersonation, and P(E|φ) representing a probability that the competent authority overlooks any fraud made by the relevant applicant in the procedure for issuance of the residence card.

Also, P(S21) is the product of P(Sφ) representing a probability that when the applicant selects, as the document for identity verification, a set of the a health insurance card and an employee ID card, the residence card required in the application procedure for issuance of the health insurance card has been acquired by impersonation, and P(E|φ) representing a probability that the competent authority overlooks any fraud made by the relevant applicant in the procedure for issuance of the residence card.

Formula [8]

P(S₀)=0.6·{⅚·P(E|φ)+⅙·P(E|F₀₁)}+0.4·{¼·P(E|φ)+¾·P(E|F₁₁)}·P(E|F₁₂) (8)

The formula 8 is obtained by replacing the formula 6 based on the formula 7 which is developed into lower-level terms, and by substituting the fraud case data in the modified formula and rearranging it.

Returning to operation S140, if any term of P(Sij) [i≧0, j≧1] remains no longer (No in operation S140), the fraud risk evaluating unit 41 produces a final probability formula (operation S170), for example, by combining similar terms together. Thereafter, the process is brought to an end. The following formula 9, for example, is produced as a final probability formula from the formula 8.

[Formula 9]

P(S₀)=0.6·P(E|φ)+0.1·P(E|F₀₁)+0.3·P(E|F₁₁) (9)

The reason why P(E|F12)=1 is set here on the assumption that the competent authority always overlooks an employee ID card issued by a company which has not a record or career. Desirably, the fraud risk evaluating unit 41 is caused to execute the above-described determination process so that the final probability formula is more simplified. Each of the coefficients on the right side of the formula 9 represents a degree of possibility that a fraudulent document is used in presenting each of the documents for identity verification, i.e., the residence card, the driver's license or the health insurance card (strictly speaking, a degree of possibility of cheating in the case of the residence card) when fraudulent applications are performed in the application procedures for issuance of the passports. In other words, it is understood that, from the viewpoint of preventing frauds in the application procedure for issuance of the passports, it is most effective to increase a difficulty in acquiring the residence card by impersonation, which has a maximum coefficient value.

As described above, the fraud risk evaluating unit 41 determines the probability formula capable of providing a proportion at which the document for identity verification is fraudulently employed. The fraud risk evaluating unit 41 outputs the processing result to the output processing unit 50.

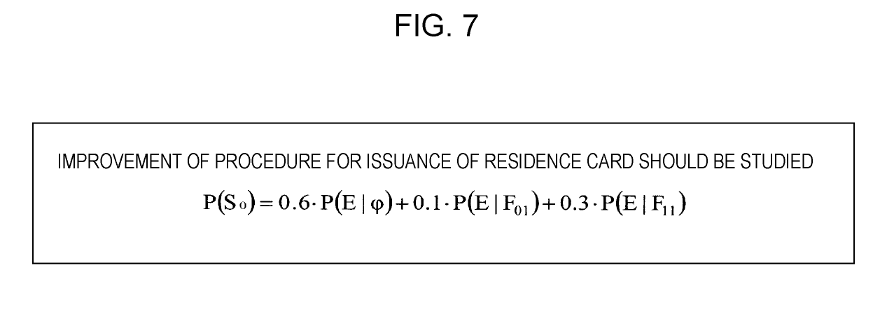

The output processing unit 50 includes a display, for example, and outputs the results of various types of processes. More specifically, when the output processing unit 50 receives the probability formula from the fraud risk evaluating unit 41, the output processing unit 50 outputs information shown, by way of example, in FIG. 7 to the display. FIG. 7 illustrates an example of the information displayed on the display.

### Advantages of First Embodiment

According to the first embodiment, as described above, the relationships between a document group and procedures which are required to acquire a target document for identity verification, which are necessary in a predetermined application, are prepared based on the relationships between each document for identity verification and one or more other documents and procedures required for acquiring the relevant each document for identity verification. The prepared relationships are stored as an identity verification diagram for the predetermined application.

Fraud cases having occurred in the application procedures and/or in acquiring some document for identity verification are accepted. Based on the identity verification diagram and the fraud case data, which one of the documents for identity verification is presented using a fraudulent document with a higher possibility is evaluated when fraudulent applications are performed in the application procedure. In other words, it is possible to quantitatively evaluate a degree of possibility that a fraudulent document is used in presenting each of the documents for identity verification when fraudulent applications are performed in the predetermined application procedure.

### Second Embodiment

A second embodiment will be described in connection with the case where a probability at which fraudulent applications are performed in the predetermined application procedure and succeed in passing the procedure is calculated by substituting estimated values in variables that remain in the formula produced by the fraud risk evaluating unit 41.

### Configuration of Application-Procedure Fraud Risk Evaluation Apparatus According to Second Embodiment

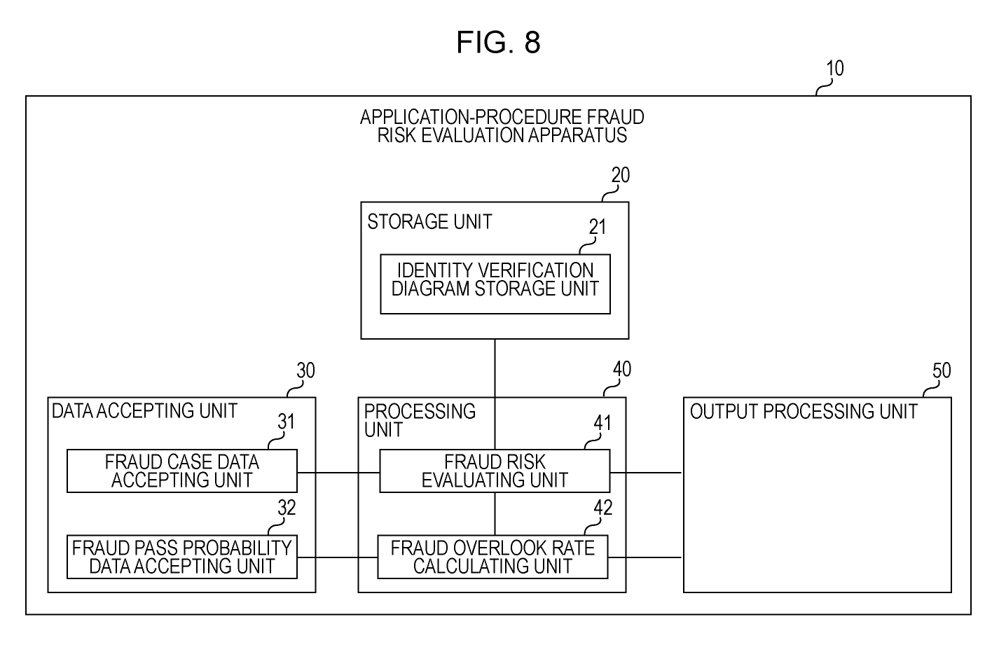

The configuration of an application-procedure fraud risk evaluation apparatus according to the second embodiment will be described with reference to FIG. 8. FIG. 8 is a block diagram showing the configuration of the application-procedure fraud risk evaluation apparatus according to the second embodiment.

As shown in FIG. 8, an application-procedure fraud risk evaluation apparatus 10 comprises a storage unit 20, a data accepting unit 30, a processing unit 40, and an output processing unit 50 as in the first embodiment. The application-procedure fraud risk evaluation apparatus 10 of the second embodiment differs from the apparatus of the first embodiment in that the data accepting unit 30 additionally includes a fraud pass probability data accepting unit 32 and the processing unit 40 additionally includes a fraud overlook rate calculating unit 42. A description of the components which operate in the same manner and have the same functions as those in the first embodiment is omitted here. The following description is made of the fraud pass probability data accepting unit 32, the fraud overlook rate calculating unit 42, and the output processing unit 50.

The fraud pass probability data accepting unit 32 accepts, as fraud pass probability data, a probability at which the attempts of fraudulently acquiring any document for identity verification succeed in passing the procedure. In other words, the probability at which the attempts of fraudulently acquiring any document for identity verification succeed in passing the procedure means a probability at which the competent authority overlooks the frauds. For example, such a probability is expressed by each of variables P(E|φ), P(E|F01) and P(E|F11) in the right side of the formula 9.

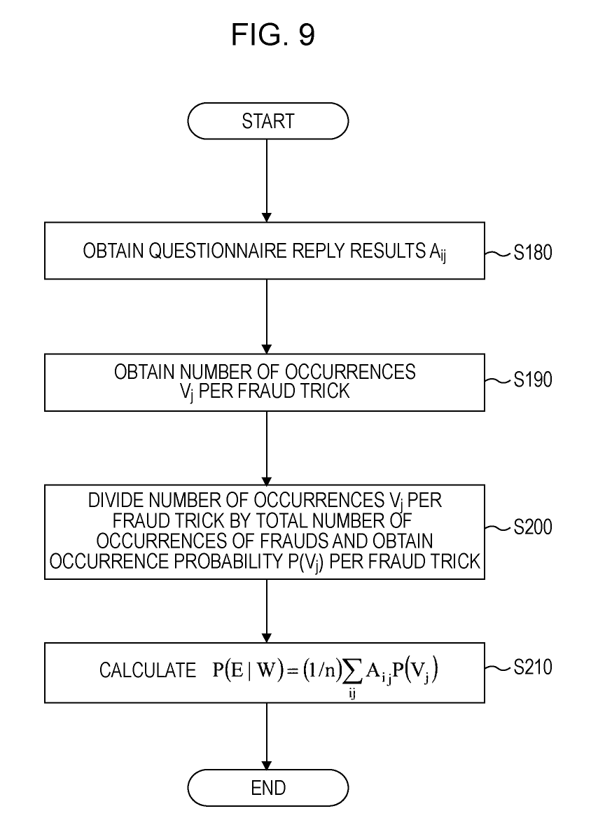

An estimated value of each probability can be obtained based on undercover experiments using tricks of actual fraud cases and/or a questionnaire survey made on the competent authority. A method of obtaining the estimated value of each probability based on the questionnaire survey made on the competent authority will be described below with reference to FIG. 9. FIG. 9 is a flowchart for explaining the method of obtaining the estimated value based on the questionnaire survey.

First, the competent authority is inquired to reply, by using a 5-score method, a degree of possibility that the competent authority may overlook each of the fraudulent tricks actually used. Assuming the number of inquired competent authorities to be n and the number of fraudulent tricks to be m, reply values (results) Aij (i=1 to n, j=1 to m) are obtained (operation S180). Then, the number of occurrences Vj per fraudulent trick actually used is obtained (operation S190). Then, the number of occurrences Vj per fraudulent trick is divided by the total number of occurrences of frauds to obtain an occurrence probability P(Vj) per fraudulent trick (operation S200). Finally, the following formula 10 is calculated (operation S210).

$$\begin{matrix}[ Formula 10 ] & \\ P ( E \vert W ) = ( 1 \text{/} n ) {\sum }_{ij} {A}_{ij} P ( {V}_{j} ) & ( 10 )\end{matrix}$$

The above-described method is applied to any of various events, i.e., the event that the applicant forges the document for identity verification, the event that the document for identity verification has already been acquired by impersonation, and the event that cheating is made in the procedure (denoted by φ in FIG. 2) for which any formal certificate is not essential. Therefore, those events are collectively represented by P(E|W).

Based on both the evaluation result by the fraud risk evaluating unit 41 and the fraud pass probability data, the fraud overlook rate calculating unit 42 calculates a probability at which a fraudulent application is performed in the predetermined application and is successfully completed (passed). More specifically, when the fraud overlook rate calculating unit 42 receives the fraud pass probability data (P(E|φ)=0.9, P(E|F01)=0.8, and P(E|F11)=0.7) from the fraud pass probability data accepting unit 32, the fraud pass probability data is substituted in the variables remaining in the formula 9 that is the final probability formula produced by the fraud risk evaluating unit 41, and 0.83 is calculated as a probability at which the applicant tries to pass the application procedure for issuance of the passport under the guise of another person. The fraud overlook rate calculating unit 42 then outputs the processing result to the output processing unit 50.

Alternatively, based on both the evaluation result by the fraud risk evaluating unit 41 and the fraud pass probability data, the fraud overlook rate calculating unit 42 may calculate a probability at which a fraudulent application is performed in the predetermined application and is successfully completed (passed), per combination of the documents for identity verification which are required in the predetermined application. More specifically, when the fraud overlook rate calculating unit 42 receives the fraud pass probability data (P(E|F12)=1.0, P(E|φ)=0.9, P(E|F01)=0.8, and P(E|F11)=0.7) from the fraud pass probability data accepting unit 32, the fraud pass probability data is substituted in the variables remaining in the formula 9 that is produced by the fraud risk evaluating unit 41.

Further, as respective values of a probability at which the applicant tries to pass the application procedure for issuance of the passport under the guise of another person, 0.88 is calculated as a probability of the case where the driver's license is selected as the document for identity verification, and 0.75 is calculated as a probability of the case where a set of the health insurance card and the employee ID card is selected as the documents for identity verification.

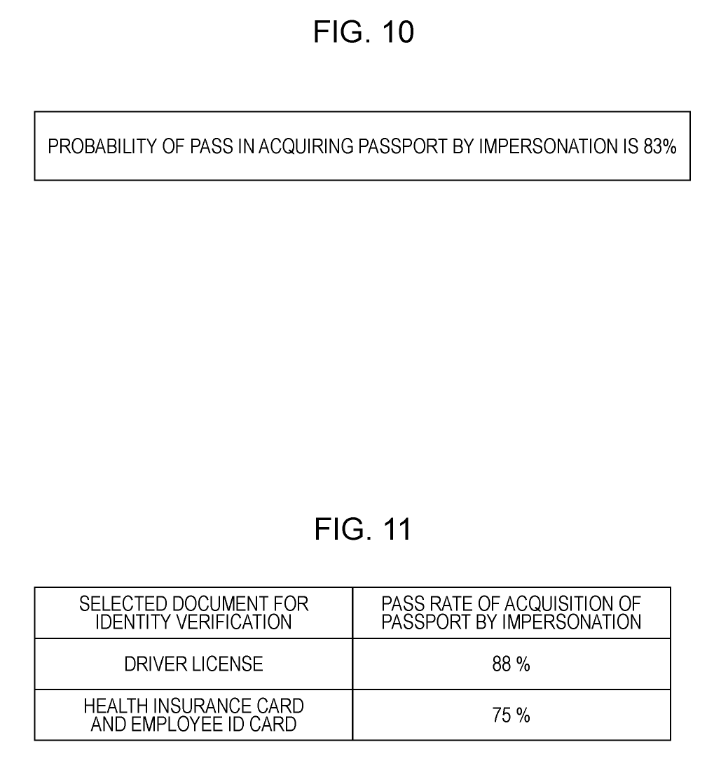

The output processing unit 50 includes a display, for example, and outputs the results of various types of processes. More specifically, when the output processing unit 50 receives the processing result from the fraud overlook rate calculating unit 42, the output processing unit 50 outputs information shown, by way of example, in FIGS. 10 and 11 to the display.

### Advantages of Second Embodiment

According to the second embodiment, as described above, the probability at which the attempts of fraudulently acquiring any document for identity verification succeed in passing the procedure is accepted as the fraud pass probability data, the probability at which a fraudulent application is performed in the predetermined application and is successfully completed is calculated by using the final probability formula produced in the first embodiment. As a result, when fraudulent applications are attempted in the predetermined procedure, the probability of those attempts successfully passing the procedure can be calculated.

### Third Embodiment

A third embodiment will be described in connection with the case of quantitatively evaluating the fraudulent risk from still another point of view while using the probability that has been calculated by the fraud overlook rate evaluating unit 42.

### Configuration of Application-Procedure Fraud Risk Evaluation Apparatus According to Third Embodiment

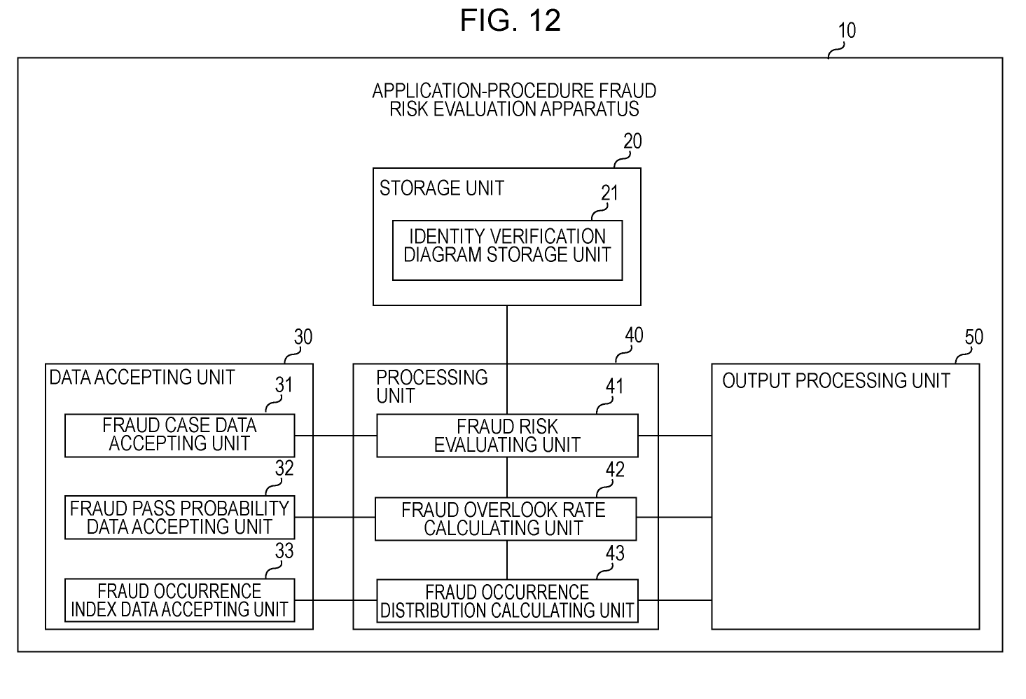

The configuration of an application-procedure fraud risk evaluation apparatus according to the third embodiment will be described with reference to FIG. 12. FIG. 12 is a block diagram showing the configuration of the application-procedure fraud risk evaluation apparatus according to the third embodiment.

As shown in FIG. 12, an application-procedure fraud risk evaluation apparatus 10 comprises a storage unit 20, a data accepting unit 30, a processing unit 40, and an output processing unit 50 as in the second embodiment. The application-procedure fraud risk evaluation apparatus 10 of the third embodiment differs from the apparatus of the second embodiment in that the data accepting unit 30 additionally includes a fraud occurrence index data accepting unit 33 and the processing unit 40 additionally includes a fraud occurrence distribution calculating unit 43. A description of the components which operate in the same manner and have the same functions as those in the second embodiment is omitted here. The following description is made of the fraud occurrence index data accepting unit 33, the fraud occurrence distribution calculating unit 43, and the output processing unit 50.

The fraud occurrence index data accepting unit 33 groups (divides) the number of days from the issuance date of the document for identity verification, which has been presented in the predetermined application, to the filing date of the relevant predetermined application into zones at predetermined intervals (periods). Further, the fraud occurrence index data accepting unit 33 accepts, as fraud occurrence index data, both the number of cases in which the predetermined application has been filed during each predetermined division interval and the number of fraudulent cases that have occurred in the predetermined application during the same interval.

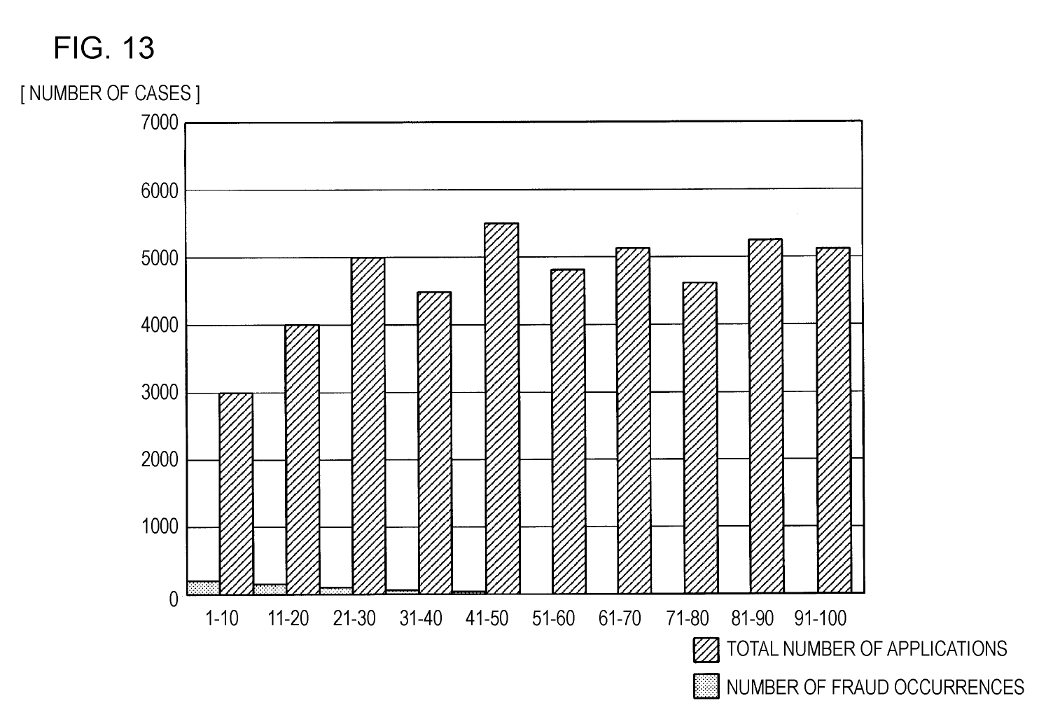

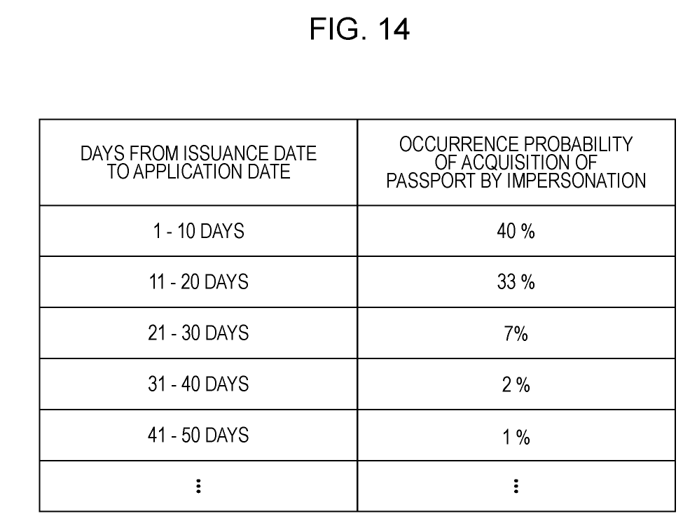

FIG. 13 is a graph showing an example of a distribution of periods in which frauds have occurred in applications for issuance of passports. The fraud occurrence index data accepted by the fraud occurrence index data accepting unit 33 will be described with reference to FIG. 13. In a bar graph of FIG. 13, the horizontal axis represents each zone resulting from grouping the number of days from the issuance date of the driver's license, which has been presented in the application for issuance of the passport, to the application date of the passport at 10-day intervals, and the vertical axis represents, in the form of a bar, the total number of applications for issuance of the passports and the number of fraud occurrences for each zone represented by the horizontal axis.

For example, in the application for issuance of the passport, if the issuance date of the drive license presented by some applicant is June 10 and the date at which the applicant has filed the application for issuance of the passport is June 27, 17 days elapse from the issuance date to the application date. Accordingly, the application filed by the relevant applicant is counted as one of the total number of applications corresponding to the zone of 11 to 20 days represented by the horizontal axis. If the relevant applicant fraudulently succeeds in passing the application procedure, it is also counted as one of the number of fraud occurrences. The term “fraud occurrence index data” means data obtained by grouping the total number of passport applications and the number of frauds having occurred in the applications for issuance of the passports per division interval of days from the issuance date to the application date as shown, by way of example, in FIG. 13.

The fraud occurrence distribution calculating unit 43 calculates a probability at which fraudulent applications occur in each of the predetermined division intervals based on the calculation result by the fraud overlook rate evaluating unit 42 and the fraud occurrence index data.

More specifically, in the bar graph of FIG. 13, a ratio of the number of fraud occurrences to the total number of applications (i.e., a value resulting from dividing the number of fraud occurrences by the total number of applications) for each zone provides an index representing easiness in causing the fraud. Assuming that the fraud is performed in a larger number in practice, the index is desirably expressed by the following formula 11, i.e., a ratio resulting from multiplying the above ratio by a predetermined value.

[Formula 11]

Qᵢ=k·Hᵢ/Nᵢ (11)

More specifically, Qi represents the product of the ratio of the number of fraud occurrences Hi to the total number of applications Ni in each zone, i.e., in each interval used for grouping the number of days from the issuance date to the application date, and a predetermined value k. Note that i is determined depending on how many number of zones are provided. In FIG. 13, for example, i is from 1 to 10.

The fraud occurrence distribution calculating unit 43 calculates a probability of the occurrence of fraud applications for issuance of the passports for each zone based on both the index calculated for each zone and the probability calculated by the fraud overlook rate evaluating unit 42, e.g., the probability at which the attempts of fraudulently passing the application procedure for issuance of the passport succeed in passing the procedures (see the following formula 12). The fraud occurrence distribution calculating unit 43 then outputs the processing result to the output processing unit 50.

[Formula 12]

Rᵢ(S₀)=P(S₀)·Qᵢ (12)

In other words, a fraud occurrence probability Ri, i.e., a probability of the occurrence of fraudulent applications during each predetermined division interval, is the product of the fraud pass probability P(S0) by impersonation and the index Qi in each zone.

Alternatively, the fraud occurrence distribution calculating unit 43 may calculate the probability per combination of the documents for identity verification. In that case, the fraud occurrence index data accepting unit 33 accepts the fraud occurrence index data per combination of the documents for identity verification, which are required for the passport application. The fraud occurrence distribution calculating unit 43 calculates a probability of the occurrence of the fraudulent passport applications for each zone and per combination of the documents for identity verification based on both the accepted fraud occurrence index data and the calculation result by the fraud overlook rate calculating unit 42 per combination of the documents for identity verification.

The output processing unit 50 includes a display, for example, and outputs the results of various types of processes. More specifically, when the output processing unit 50 receives the processing result from the fraud occurrence distribution calculating unit 43, the output processing unit 50 outputs information shown, by way of example, in FIG. 14 to the display.

### Advantages of Third Embodiment

According to the third embodiment, as described above, the number of days from the issuance date of the document for identity verification, which has been presented in the predetermined application, to the application date is grouped (divided) at the predetermined intervals, and both the number of cases in which the predetermined application has been filed during each predetermined division interval and the number of frauds having occurred in the predetermined application during the same interval are accepted as the fraud occurrence index data.

Further, the probability of the occurrence of fraudulent applications is calculated for each predetermined division interval by using the fraud overlook rate calculated in the second embodiment. Thus, by grouping the number of days from the issuance date of the document for identity verification, which has been presented in the predetermined application, to the application date at the predetermined intervals, the probability of the occurrence of fraudulent applications can be calculated for each predetermined division interval.

Further, by informing the fraud occurrence probability to the competent authority, the competent authority can determine whether any stricter identity verification means is to be added depending on a value of the fraud occurrence probability, and if necessary, the competent authority may adopt the stricter identity verification means as an additional system. In addition, by increasing a degree of strictness of the added identity verification means depending on respective values of the fraud occurrence probability, a system can be realized in which the time and cost of examination are well balanced with durability against the fraud risk.

As described above, the application-procedure fraud risk evaluation apparatus according to the present invention is suitable for quantitatively evaluating in which one of the documents for identity verification a fraudulent document is presented with a higher possibility when fraudulent applications are performed in the predetermined application procedure

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An application-procedure fraud risk evaluation apparatus comprising:
identity verification diagram holding means for preparing, based on relationships between each document for identity verification and one or more other documents and procedures required for acquiring the each document for identity verification, relationships between a document group and procedures which are required to acquire a target document for identity verification, which is necessary in a predetermined application, and for holding the prepared relationships as an identity verification diagram for the predetermined application;
fraud case data accepting means for accepting, as fraud case data, fraudulent cases that have occurred in the application procedures and/or in acquiring the each document for identity verification; and
fraud risk evaluating means for evaluating, based on the identity verification diagram and the fraud case data, in which one of the documents for identity verification a fraudulent document is presented with a higher possibility when fraudulent applications are performed in the application procedures.

2. The application-procedure fraud risk evaluation apparatus according to claim 1, further comprising:
fraud pass probability data accepting means for accepting, as fraud pass probability data, a probability at which attempts of fraudulently acquiring the each document for identity verification succeed; and
fraud overlook rate calculating means for, based on both an evaluation result by the fraud risk evaluating means and the fraud pass probability data, calculating a probability at which the fraudulent applications are filed and completed.

3. The application-procedure fraud risk evaluation apparatus according to claim 1, further comprising:
fraud pass probability data accepting means for accepting, as fraud pass probability data, a probability at which attempts of fraudulently acquiring the each document for identity verification succeed; and
fraud overlook rate calculating means for, based on both an evaluation result by the fraud risk evaluating means and the fraud pass probability data, calculating a probability at which the fraudulent applications are filed and completed, per combination of the documents for identity verification, which are necessary in the predetermined application.

4. The application-procedure fraud risk evaluation apparatus according to claim 2, further comprising:
fraud occurrence index data accepting means for grouping the number of days from an issuance date of the document for identity verification, which has been presented in the predetermined application, to an application date of the predetermined application into zones at predetermined intervals, and for accepting, as fraud occurrence index data, both the number of cases in which the predetermined application has been filed during each predetermined division interval and the number of fraudulent cases that have occurred in the predetermined application during the same interval; and
fraud occurrence distribution calculating means for, based on both a calculation result by the fraud overlook rate calculating means and the fraud occurrence index data, calculating a probability at which the fraudulent applications occur during the each predetermined division interval.

5. The application-procedure fraud risk evaluation apparatus according to claim 2, further comprising:
fraud occurrence index data accepting means for grouping the number of days from an issuance date of the document for identity verification, which has been presented in the predetermined application, to an application date of the predetermined application into zones at predetermined intervals, and for accepting, as fraud occurrence index data, both the number of cases in which the predetermined application has been filed during each predetermined division interval and the number of fraudulent cases that have occurred in the predetermined application during the same interval per combination of the documents for identity verification, which are necessary in the predetermined application; and
fraud occurrence distribution calculating means for, based on both a calculation result by the fraud overlook rate calculating means and the fraud occurrence index data, calculating a probability at which the fraudulent applications occur during the each predetermined division interval per combination of the documents for identity verification, which are necessary in the predetermined application.

6. A method of application-procedure fraud risk evaluation, comprising:
preparing relationships between a document group and procedures which are required to acquire a target document for identity verification based on relationships between each document for identity verification and one or more other documents and procedures required for acquiring the each document for identity verification, which are necessary in a predetermined application;
holding the prepared relationships as an identity verification diagram for the predetermined application;
accepting fraudulent cases that have occurred in the application procedures or in acquiring the each document for identity verification as fraud case data; and
evaluating in which one of the documents for identity verification a fraudulent document is presented with a higher possibility when fraudulent applications are performed in the application procedures based on the identity verification diagram and the fraud case data.

7. The method of application-procedure fraud risk evaluation of claim 6, further comprising:
accepting a probability at which attempts of fraudulently acquiring the each document for identity verification succeed as fraud pass probability data; and
calculating a probability at which the fraudulent applications are filed and completed based on both the evaluation and the fraud pass probability data.

8. The method of application-procedure fraud risk evaluation of claim 6, further comprising:
accepting a probability at which attempts of fraudulently acquiring the each document for identity verification succeed as fraud pass probability data; and
calculating a probability at which the fraudulent applications are filed and completed, per combination of the documents for identity verification, which are necessary in the predetermined application based on both an evaluation result by the fraud risk evaluating means and the fraud pass probability data.

9. The method of application-procedure fraud risk evaluation of claim 7, further comprising:
grouping the number of days from an issuance date of the document for identity verification, which has been presented in the predetermined application, to an application date of the predetermined application into zones at predetermined intervals;
accepting, as fraud occurrence index data, both the number of cases in which the predetermined application has been filed during each predetermined division interval and the number of fraudulent cases that have occurred in the predetermined application during the same interval; and
calculating a probability at which the fraudulent applications occur during the each predetermined division interval based on both a calculation result by the fraud overlook rate calculating means and the fraud occurrence index data.

10. The method of application-procedure fraud risk evaluation of claim 7, further comprising:
grouping the number of days from an issuance date of the document for identity verification, which has been presented in the predetermined application, to an application date of the predetermined application into zones at predetermined intervals;
accepting, as fraud occurrence index data, both the number of cases in which the predetermined application has been filed during each predetermined division interval and the number of fraudulent cases that have occurred in the predetermined application during the same interval per combination of the documents for identity verification, which are necessary in the predetermined application; and
calculating a probability at which the fraudulent applications occur during the each predetermined division interval per combination of the documents for identity verification, which are necessary in the predetermined application based on both a calculation result by the fraud overlook rate calculating means and the fraud occurrence index data.
